(19) United States
(12) Patent Application Publication
(10) Pub. No.: US 2012/0189847 A1
(43) Pub. Date: Jul. 26, 2012

(54) MARINE POLYESTER YARN AND PREPARATION METHOD THEREOF

(75) Inventors: Young-Soo Lee, Gumi-si (KR); Young-Jo Kim, Gimpo-si (KR); Gi-Woong Kim, Daegu (KR); Hyun-Jung Park, Dae-gu (KR)

(73) Assignee: KOLON INDUSTRIES, INC., Kyungki-do (KR)

(21) Appl. No.: 13/499,590

(22) PCT Filed: Sep. 30, 2010
(86) PCT No.: PCT/KR2010/006675

§ 371 Date: Mar. 30, 2012

(30) Foreign Application Priority Data
Sep. 30, 2009 (KR) 10-2009-0092936
Dec. 30, 2009 (KR) 10-2009-0134474

(51) Int. Cl. D02G 3/44; B29C 55/00; B29C 47/00

(52) U.S. Cl. 428/375; 264/210.3

(57) ABSTRACT

The present invention relates to a marine polyester yarn used in the anchoring of an oil prospecting ship for oil field development in the deep sea, in particular, a marine polyester yarn prepared by surface-treatment of a polyester fiber with an oil component, which has a work recovery or creep rate within the predetermined range in a cycling test according to the ASTM D885 method of the American Society for Testing and Materials, and a preparation method thereof.

The marine polyester yarn of the present invention is a lightweight fiber rope, compared to the known wire ropes, and thus can be conveniently used. Simultaneously, it is excellent in terms of mechanical strength, abrasion resistance, and shape stability, thereby being used as a marine yarn for a long time.

### CROSS REFERENCES TO RELATED APPLICATION

This application claims priority to and the benefit of Korean Patent Application No. 10-2009-0092936 filed in the Korean Industrial Property Office on Sep. 30, 2009 and No. 10-2009-0134474 filed in the Korean Industrial Property Office on Dec. 30, 2009, which are hereby incorporated by reference for all purposes as if fully set forth herein.

### BACKGROUND OF THE INVENTION

(a) Field of the Invention

The present invention relates to a marine polyester yarn used in the anchoring of an oil prospecting ship for oil field development in the deep sea, and a preparation method thereof.

(b) Description of the Related Art

In general, a marine yarn is used in the anchoring of an oil prospecting ship for oil field development in the deep sea.

Steel wire ropes have been commonly used before, but their weight has generated many problems when used in the deep sea deeper than 2,000 m.

Further, the wire rope used for the anchoring of an oil prospecting ship for oil field development in the deep sea is usually required to have a 4-year life guarantee (35,000 hours) in the seawater. When used in seawater for a long time, the wire rope is exposed to corrosive environments, and abrasion of the metal is occasionally caused by marine environment such as salt water or sand. In many cases, the wire rope can have broken wires in 2˜3 years due to the seawater corrosion and abrasion. Thus, rope replacement is needed so that the guarantee cannot be assured. Therefore, an expensive corrosion resistant coating process is additionally required.

In order to solve these problems, the wire rope has been replaced with a lightweight fiber rope having high strength and excellent shape stability. Compared to the wire rope, however, the known fiber ropes may have a partial breakage by frictional heat due to environmental changes, and the long-term use thereof may cause a complete breakage, leading to high risk situations.

In particular, when the known fiber ropes are used in seawater for a long time of about 5˜10 years, there are problems in that wire rope fatigue is increased by continuous environmental movement such as tidal stream, and fiber deformation occurs to remarkably reduce mechanical strength such as product strength.

Accordingly, there is a need to develop a preparation method of a marine fiber yarn, which minimizes frictional heat due to environmental changes to prevent damage such as partial breakage, and simultaneously provides the fiber yarn with excellent abrasion resistance, mechanical strength, and shape stability to prevent a reduction in the strength even though used for a long time.

### SUMMARY OF THE INVENTION

It is an aspect of the present invention to provide a marine polyester yarn having excellent abrasion resistance, mechanical strength, and shape stability even though immersed in seawater for a long time, and a preparation method thereof.

The present invention provides a marine polyester yarn prepared by surface-treatment of a polyester fiber with an oil component, in which a creep rate defined by the following Equation 1 is 9% or less when the fiber is fixed to have an initial length of 1.4 m and is left for 24 hours under a load of 50% breaking strength of the yarn;

Creep rate=(L−L₀)/L₀×100 [Equation 1]

wherein L is a deformed length after keeping it for 24 hours under a load, and

L₀ is an initial length of the yarn to be 1.4 m.

The present invention also provides a marine polyester yarn prepared by surface-treatment of a polyester fiber with an oil component, in which a work recovery defined by the following Equation 2 is 55% or more when a cycling test is performed 5 to 10 times under a load of 3.5 g/d according to the ASTM D885 method of the American Society for Testing and Materials, and a work recovery defined by the following Equation 2 is 50% or more when a cycling test is performed 5 to 10 times under a load of 6.5 g/d according to the ASTM D885 method of the American Society for Testing and Materials;

Work recovery (%)=W₂/W₁×100 [Equation 2]

wherein W₁ is Total Work done in Extension in the cycling test according to the ASTM D885 method of the American Society for Testing and Materials, and

W₂ is Work returned during Recovery in the cycling test according to the ASTM D885 method of the American Society for Testing and Materials.

The present invention further provides a method for preparing a marine polyester yarn, comprising the steps of melt-spinning a polyester polymer to prepare an undrawn polyester filament yarn, surface-treating the undrawn polyester filament yarn with an oil composition containing a polysiloxane compound, and drawing the undrawn polyester filament yarn under the heat treatment condition of 70 to 250° C. to contain the polysiloxane compound of 40% by weight or more based on the total weight of the oil component surface-treated to the yarn.

### BRIEF DESCRIPTION OF THE DRAWINGS

FIG. 1 is a schematic diagram illustrating the preparation process of a marine polyester yarn according to one embodiment of the present invention;

FIG. 2 is a graph showing the cycling test result of the marine polyester yarn according to one embodiment of the present invention;

FIG. 3 is a schematic diagram of a yarn-on-yarn abrasion test apparatus according to one embodiment of the present invention;

FIG. 4 is a schematic diagram of a creep tester used for the measurement of creep rate according to one embodiment of the present invention;

FIG. 5 is a schematic diagram of an apparatus used for the measurement of work recovery according to one embodiment of the present invention;

FIG. 6 is a photograph showing the result of yarn-on-yarn abrasion test according to Example 4 of the present invention; and

FIG. 7 is a photograph showing the result of yarn-on-yarn abrasion test according to Comparative Example 1 of the present invention.

### DETAILED DESCRIPTION OF THE EMBODIMENTS

Hereinafter, the marine polyester yarn according to embodiments of the present invention and the method of preparing the same are explained in more detail. However, the following is only for understanding of the present invention and the scope of the present invention is not limited to or by them, and it is obvious to a person skilled in the related art that the embodiments can be variously modified in the scope of the present invention.

In addition, “include” or “comprise” means to include any components (or ingredients) without particular limitation unless there is no particular mention about them in this description, and it cannot be interpreted as a meaning of excluding an addition of other components (or ingredients).

In order to develop a marine yarn having excellent abrasion resistance, mechanical strength, and shape stability, the present invention is characterized in that a polyester yarn is ensured to have a creep rate or work recovery within the optimal range by surface-treatment of a polyester fiber with an oil component.

The creep rate of the marine polyester yarn of the present invention can be defined by the following Equation 1, and the polyester yarn has a creep rate of 9% or less when the sample is fixed to have an initial length L₀ of 1.4 m and is left for 24 hours under a load of 50% breaking strength of the yarn;

Creep rate=(L−L₀)/L₀×100 [Equation 1]

wherein L is a length of the yarn after keeping it for 24 hours, and L0 is an initial length of the yarn of 1.4 m when the sample is fixed in a creep tester.

Herein, a breaking strength of the yarn can be measured according to the ASTM D 2256 method, and it can be 15 kgf to 25 kgf, preferably 17 kgf to 21 kgf, and more preferably 18 kgf to 20 kgf. In particular, if a 2,000 denier yarn is used, the load of 50% breaking strength of the yarn can be 6 kg to 12 kg, preferably 8 kg to 10 kg, and more preferably 9 kg.

The polyester yarn of the present invention has the low creep rate of 9% or less, or 0 to 9%, preferably 6% or less, or 2% to 6%, and more preferably 5% or less, or 3% to 5%, when left for 24 hours, thereby showing less deformation and excellent shape stability under load variation. Therefore, deformation of the product hardly occurs, even though the polyester yarn is immersed in seawater for a long time and exposed to environmental changes such as tidal stream. Owing to the excellent shape stability, the polyester yarn minimizes the strength reduction and can be effectively used for a long time of about 5˜10 years, when applied as a marine yarn.

Further, the work recovery (Energy Recovery) of the marine polyester yarn of the present invention can be defined by the following Equation 2, and the polyester yarn has the work recovery (Energy Recovery) of 55% or more and 50% or more, respectively, when a cycling test is performed 5 to 10 times under the load of 3.5 and 6.5 g/d according to the ASTM D885 method of the American Society for Testing and Materials.

Work recovery (%)=W₂/W₁×100 [Equation 2]

wherein W₁ is Total Work done in Extension in the cycling test according to the ASTM D885 method of the American Society for Testing and Materials, and

W₂ is Work returned during Recovery in the cycling test according to the ASTM D885 method of the American Society for Testing and Materials.

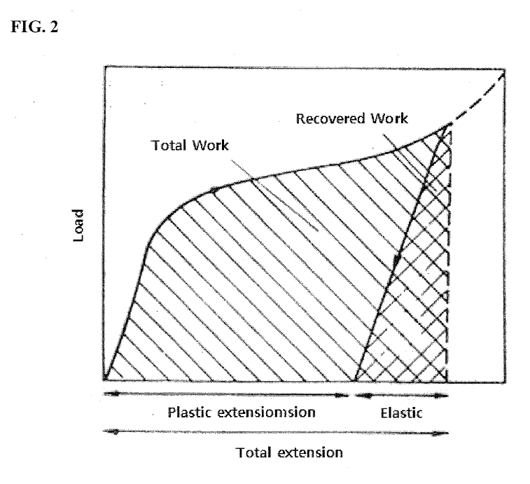

In particular, in one preferred embodiment of the present invention, the work recovery of Equation 2 can be calculated from W₁ that is a total work done when the original yarn is extended to a predetermined load and W₂ that is work returned during recovery when the applied predetermined load is removed after the cycling, as in FIG. 2 showing a graph of load versus extension of the cycling test result.

The polyester yarn of the present invention has the work recovery defined by Equation 2 of 55% or more and 50% or more, respectively, when a cycling test is performed using a universal tensile machine at room temperature (25° C.) 5 to 10 times under the load of 3.5 and 6.5 g/d according to the ASTM D885 method of the American Society for Testing and Materials. That is, the work recovery (Energy Recovery) of the polyester yarn may be 55% or more, or 55% to 95%, and preferably 60% or more, or 60% to 95% when measured under the load of 3.5 g/d. In addition, the polyester yarn may have the work recovery (Energy Recovery) of 50% or more, or 50% to 90%, and preferably 55% or more, or 55% to 90% when measured under the load of 6.5 g/d. The polyester yarn of the present invention has the high work recovery value, thereby showing less deformation and excellent shape stability under load variation. Therefore, deformation of the product hardly occurs, even though the polyester yarn is immersed in seawater for a long time and exposed to environmental changes such as tidal stream. Owing to the excellent shape stability, the polyester yarn of the present invention minimizes the strength reduction and can be effectively used for a long time of about 5˜10 years, when applied as a marine yarn.

The polyester yarn may have the work recovery of 75% or more, or 75% to 96%, and preferably 80% or more, or 80% to 96% when measured under the load of 2.0 g/d. In addition, the polyester yarn may have the work recovery of 35% or more, or 35% to 85%, and preferably 40% or more, or 40% to 85% when measured under the load of 8.5 g/d.

Meanwhile, as described above, the polyester yarn of the present invention is characterized in that the polyester fiber is surface-treated with an oil component to obtain excellent performances required to be used as a marine finish yarn for a long time.

The term ‘polyester fiber’, as used herein, refers to a fibrous polymer obtained by esterification of a diol compound and a dicarboxylic acid such as terephthalic acid, and corresponds to the basic fiber component for the preparation of the ‘marine polyester yarn’ of the present invention. Polyester has excellent humidity resistance, and thus is more preferably used for the preparation of an alternative fiber rope to the marine wire rope.

The polyester fiber of the present invention may include any commonly used polyester fiber, and for example, polyalkylene terephthalate such as polyethylene terephthalate (PET), polyethylene naphthalate (PEN), polybutylene terephthalate (PBT), and polycyclohexanedimethylene terephthalate (PCT) or a copolyester including the same as a main component. Especially, polyethylene terephthalate is more preferable for the marine yarn in terms of physical properties such as strength and elongation.

The polyester fiber may have an intrinsic viscosity of 8.0 to 1.20 dl/g, and preferably 0.90 to 1.05 dl/g, and it is preferable that the intrinsic viscosity is within the above range in terms of high strength.

Further, the term ‘oil component’, as used herein, refers to all components that maximize surface-lubricating effects by physical or chemical binding to the surface of polyester. According to the preferred embodiment of the present invention, the oil component may include, for example, a polysiloxane compound, an emulsifying agent, and a solvent.

In particular, the oil component may be only composed of the polysiloxane compound and emulsifying agent, or only the polysiloxane compound. That is, it means that the oil component includes the polysiloxane compound only as a major component for actually providing the surface of polyester with the lubricity, and does not include other lubricants. In this regard, to improve the processing performances of the polysiloxane compound, an emulsifying agent may be further included, but no other components are actually included. However, as long as the solvent is not detected as residual impurities during the processing, it can be included in a small amount, that is, in an amount of 1% by weight or less, based on the total weight of the oil component.

The experimental results of the present inventors showed that the polysiloxane compound is only used as a lubricating agent in the oil component for the surface treatment of polyester fiber, thereby providing excellent abrasion resistance, shape stability, and mechanical strength, compared with other polyester yarns that are surface-treated with an oil component including other lubricating agent or anti-static agent, an antioxidant/anti-aging agent.

In the present invention, the oil component is characterized in that it contains the polysiloxane compound of 40% by weight or more, preferably 50% by weight or more, 60% by weight or more, or 70 to 90% by weight, based on the total weight of the oil component of the final polyester yarn. To provide the polyester yarn of the present invention with high strength and excellent creep properties and work recovery rate required for the marine finish yarn, and to simultaneously provide it with excellent abrasion resistance for long-term performances, the polyester fiber is preferably surface-treated with the oil component having the high content of the polysiloxane compound.

The polysiloxane compound has no reactive functional groups, thereby providing the surface of the yarn with excellent stability and lubricity. In particular, the higher content thereof provides very excellent water-repellent property to completely prevent water infiltration and provides excellent abrasion resistance and mechanical properties. However, there is a problem in that when the high content of polysiloxane compound is applied to the yarn, the viscosity is increased to remarkably reduce operability, and thus the prepared yarn does not have a uniform quality. As described below, when the high content of polysiloxane compound is applied to the yarn, together with the emulsifying agent and the solvent, or together with the solvent only, operability of the overall process can be improved, and the marine polyester yarn having excellent physical properties can be prepared.

Further, the polysiloxane compound may be included in the oil component in an amount of 0.5 to 2.0% by weight, and preferably 0.6 to 1.1% by weight, based on the weight of the polyester fiber. In terms of abrasion resistance, it is preferably included in an amount of 0.5% by weight or more, based on the weight of the polyester fiber. Economically, it is preferably included in an amount of 2.0% by weight or less.

In the present invention, the polysiloxane compound may be represented by the following Chemical Formula 1, and each compound may be used alone or in combination of two or more:

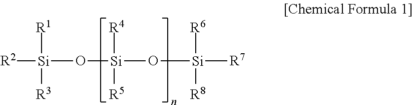

wherein R¹, R², R³, R⁴, R⁵, R⁶, and R⁷ are independently the same as or different from each other, and hydrogen, C₁˜C₂₀ alkyl group, or C₁˜C₂₀ aryl group, and

n is an integer of 1˜10,000, and preferably an integer of 1˜5,000.

The polysiloxane compound may have a number-average molecular weight of 10 to 1,000,000, preferably 50 to 500,000, and more preferably 500 to 500,000. In addition, the polysiloxane compound may have a viscosity of 5 to 35,000 cst, preferably 50 to 5,000 cst, and more preferably 100 to 500 cst. To ensure excellent lubricating effect as a marine yarn, the polysiloxane compound having a number-average molecular weight of 10 or more or a viscosity of 5 cst or more may be used. Considering that increasing molecular weight and viscosity of the polysiloxane compound reduce its diffusion and infiltration rate, the number-average molecular weight is preferably 1,000,000 or less, or the viscosity is preferably 35,000 cst or less.

In this regard, the viscosity of the polysiloxane compound can be measured using a Cannon-Fenske Type viscometer according to a dynamic viscosity measurement method.

The polysiloxane compound having a specific gravity of 0.950 to 1.000 at room temperature (25° C.) may be also used.

In one preferred embodiment, the polysiloxane compound of the present invention may have alkyl having 1 to 4 carbon atoms as at least one of the substituent R4 or R5 in Chemical Formula 1, and for example, it may be one or more selected from the group consisting of polydialkylsiloxane and polyalkylarylsiloxane. More preferably, the polysiloxane compound of the present invention may be one or more selected from the group consisting of polydimethylsiloxane, polydiethylsiloxane, and polymethylphenylsiloxane, and most preferably polydimethylsiloxane in terms of the quality of the final product.

In addition, the oil component of the present invention may further include an emulsifying agent together with the polysiloxane compound. The emulsifying agent reduces the coefficient of friction between the yarn and the metal, and properly adjusts the coefficient of friction between the yarns, thereby improving reeling operability and post-processability. The high coefficient of friction between the yarns increases fullness of the yarn, thereby providing good uniformity during air interlacing process. However, the excessively high coefficient of friction between the yarns increases a risk of pilling and yarn breakage.

In the present invention, the emulsifying agent may be included in an amount of 60% by weight or less, 50% by weight or less, 40% by weight or less, 30% by weight or less, or 10 to 30% by weight, based on the total weight of the oil component of the yarn. The polyester fiber is surface-treated with the oil component having a high content of the polysiloxane compound, thereby improving operability of the process for the marine yarn preparation, and simultaneously providing the final marine yarn product with excellent abrasion resistance, and shape stability and mechanical strength, when the content of emulsifying agent is preferably less than the above range.

The emulsifying agent may be selected considering the process and device used for the preparation of the polyester fiber, the type of the polysiloxane compound, and the solvent or the like, and preferably non-ionic surfactant or the like.

In one preferred embodiment of the present invention, the emulsifying agent may be one or more selected from the group consisting of a fatty acid monoglycerin ester non-ionic surfactant, a fatty acid polyglycol ester non-ionic surfactant, a fatty acid sorbitan ester non-ionic surfactant, a fatty acid sucrose ester non-ionic surfactant, a fatty acid alkanolamide non-ionic surfactant, and a polyethylene glycol condensed non-ionic surfactant. Here, the fatty acid may have 8˜22 carbon atoms.

More specifically, the non-ionic surfactant may be selected from the group consisting of alkyl polyalkylene glycols, alkylaryl polyalkylene glycols, alkyldimethyl amine oxides, di-alkyl methyl amine oxides, alkylamidopropyl amine oxides, alkyl glucamides, alkyl polyglycosides, oxalkylated fatty acids, and alkyl amines. Here, the alkyl group may have 8˜22 carbon atoms. In this regard, the alkyl groups of the compounds may be replaced with alkene groups, and preferably have 8 to 22 carbon atoms and may be linear or branched. The alkylpolyalkylene glycol preferably contains 1 to 20 ethoxy or propoxy units. Most preferably, the non-ionic surfactant may be alkyldimethyl amine oxide and the alkyl group may have 8˜22 carbon atoms.

More specific examples may include polyoxyethylene stearyl ether, polyoxyethylene stearyl oleylether, polyoxyethylene oleylether, polyoxyethylene cetylether, polyoxyethylene lauryl ether, propylene oxide/ethylene oxide copolymer monobutyl ether, polyoxyethylene bisphenol A dilaurylate, polyoxyethylene bisphenol A laurylate, polyoxyethylene bisphenol A distearate, polyoxyethylene bisphenol A stearate, polyoxyethylene bisphenol A dioleate, polyoxyethylene bisphenol A oleate, polyoxyethylene stearyl amine, polyoxyethylene lauryl amine, polyoxyethylene oleyl amine, polyoxyethylene oleic acid amide, polyoxyethylene stearic acid amide, polyoxyethylene lauric acid ethanolamide, polyoxyethylene oleic acid ethanolamide, polyoxyethylene oleic acid diethanolamide, diethylenetriamineoleic acid amide, polyoxypropylenestearylether, polyoxypropylene bisphenol A stearate, polypropylenestearylamine, polypropyleneoleic acid amide, glyceryl mono alkylate, glyceryl tri alkylate, sorbitan mono alkylate, sorbitan tri alkylate, castor oil or the like.

Further, the present invention provides a method for preparing a marine polyester yarn having excellent abrasion resistance, shape stability, and mechanical strength. In particular, the preparation method of the present invention comprises the steps of melt-spinning a polyester polymer to prepare an undrawn polyester filament yarn, surface-treating the undrawn polyester filament yarn with an oil composition containing a polysiloxane compound, and drawing the undrawn polyester filament yarn under the heat treatment condition of 70 to 250° C. to contain the polysiloxane compound of 40% by weight or more based on the total weight of the oil component surface-treated to the yarn.

Hereinafter, exemplary embodiments of the melt-spinning and drawing processes of the present invention will be described in detail with reference with the accompanying drawings, so that they can be readily implemented by those skilled in the art.

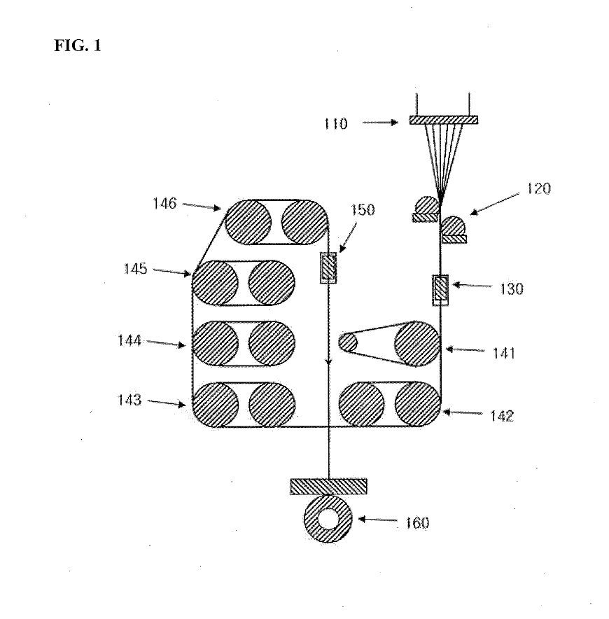

FIG. 1 is a schematic diagram illustrating the preparation process of a polyester yarn of the present invention. As a preferred embodiment shown in FIG. 1, for the preparation of the marine polyester yarn of the present invention, the undrawn polyester filament yarn is first prepared from the polyester polymer through a spinneret 110. At this time, the melted polymer spun through the spinneret is cooled with quenching-air, and the oil composition is applied to the undrawn filament yarn using an oil-roll or oil-jet 120, and the oil composition applied to the undrawn filament yarn is uniformly dispersed on the surface of the yarn with uniform air pressure using a pre-interlacer 130. After this, the undrawn yarn is drawn through multi-step drawing devices 141˜146. After the drawing process, the yarn is intermingled at a second interlacer 150 with uniform pressure, and wound with a winder 160 to prepare the final yarn of the present invention.

The melt-spinning process of the present invention may be performed according to the known method typically used for the polyester preparation, except for including the step of surface-treating the undrawn polyester filament yarn using the oil composition containing the polysiloxane compound, and is not limited to particular additional conditions.

In the preparation method of the present invention, however, the drawing process may be performed at the heat-treatment temperature of 70 to 250° C., and preferably 80 to 230° C. The drawing step is preferably performed within the above heat-treatment temperature, in order to sufficiently remove the unnecessary volatile component in the oil composition applied to the surface of the undrawn filament yarn and to prepare the drawn yarn having high strength and excellent work recovery. In addition, it is preferable that the drawing process is performed at a high drawing ratio of 4 to 7, and preferably 5 to 6.5 under the above heat-treatment condition. However, when the drawing process is performed at the high drawing ratio, operability may be practically reduced. Thus, the drawing ratio should be maintained within the optimal range to maintain excellent work recovery of the yarn and effective operability. At this time, the relaxation rate may be 1% or more, preferably 1% to 5%, and more preferably 1 to 3%, and the winding speed may be 2,500 m/min or more, preferably 2,500 to 4,500 m/min, and more preferably 2,500 to 3,500 m/min.

Specifically, the preparation method of the present invention showed that the undrawn polyester filament yarn is surface-treated with the oil composition containing the polysiloxane compound, thereby preparing a marine polyester yarn having excellent abrasion resistance, mechanical strength, creep property, and work recovery, that is, excellent shape stability.

In the present invention, the oil component containing the polysiloxane compound, that is, the spinning oil composition containing the same can be applied to the undrawn polyester filament yarn by installation of an additional device or by using the known oil-roll or oil-jet 120 as shown in FIG. 1.

The oil composition may be a composition consisting of the polysiloxane compound, the emulsifying agent, and the solvent only. That is, the oil composition contains the polysiloxane compound as a sole main ingredient that practically provides the polyester surface with a lubricity, and does not contain other lubricant. It may further contain a small amount of emulsifying agent for solubilizing the polysiloxane compound in a solvent, and contain no other components than this component. However, as long as other components are not detected as residual impurities during the processing, they can be included in a small amount, that is, in an amount of 1% by weight or less, based on the total weight of the composition.

Further, the oil composition may include the polysiloxane compound of 15 to 40% by weight, and preferably 20 to 35% by weight, the emulsifying agent of 10% by weight or less, and preferably 1 to 7% by weight or less, and the residual solvent, preferably the solvent of 60% by weight or more, and more preferably 65 to 85% by weight, based on the total composition.

As mentioned above, as the content of polysiloxane compound is increased in the oil component applied to the surface of the marine polyester yarn of the present invention, the marine yarn has very excellent stability, lubricity, water-repellent property, abrasion resistance, mechanical property and work recovery property. However, there is a problem in that high content of polysiloxane compound increases viscosity, thereby remarkably reducing the operability. Therefore, when the polysiloxane compound is solubilized in a solvent using a predetermined emulsifying agent according to the present invention, and then the solvent is removed, the operability of the yarn preparation process is improved, and a marine polyester yarn having excellent physical properties can be prepared owing to the oil component including the polysiloxane compound of preferably 40% by weight or more, and more preferably 60% by weight or more.

In the spinning oil composition of the present invention, the polysiloxane compound and the emulsifying agent are the same as described above, and the solvent can be selected considering the process and device used for the preparation of the polyester fiber, the type of the polysiloxane compound and the emulsifying agent.

In particular, the solvent may be preferably water, or petroleum-extracted normal paraffin or isoparaffin having 9 to 13 carbon atoms. If the petroleum-extracted normal paraffin or isoparaffin having 9 to 13 carbon atoms is used as the solvent, a non-ionic surfactant may be used as the emulsifying agent.

Preferably, the solvent is not contained in the oil component of the final polyester yarn after the preparation process of the yarn. However, its residue may remain, for example, in an amount of 1% by weight or less, 0.5% by weight or less, and 0.1% by weight or less. In this case, the marine yarn can be also immersed and used in seawater for a long time.

In the preparation method of the present invention, the solvent can be sufficiently removed by the heat-treatment process in the step of drawing the undrawn filament yarn, but an additional drying step may be performed to remove the solvent, if necessary.

Meanwhile, to effectively use the polyester yarn of the present invention as the marine fiber yarn, the yarn-on-yarn abrasion resistance should be measured to confirm whether the yarn breakage occurs when yarns are rubbed 5,000 cycles or more under a load of 0.34 to 0.45 g/d, that is, the yarn breakage does not occur until yarns are rubbed 5,000 cycles. In particular, the abrasion resistance is preferably retained until the rubbing is performed at least 7,000 cycles under wet conditions and at least 9,000 cycles under dry conditions. If the abrasion resistance is not retained until the rubbing is performed at least 7,000 cycles and at least 9,000 cycles under dry and wet conditions, respectively, partial breakage of the polyester yarn of the present invention occurs by friction due to environmental changes so as to cause risks to the ship or human life, when used as the marine rope.

Considering the safety as the marine rope, the yarn-on-yarn abrasion resistance is preferably retained as much frequency as possible to ensure excellent performances, and it can be typically retained at 7,000 to 18,000 cycles and 9,000 to 20,000 cycles under wet and dry conditions, respectively.

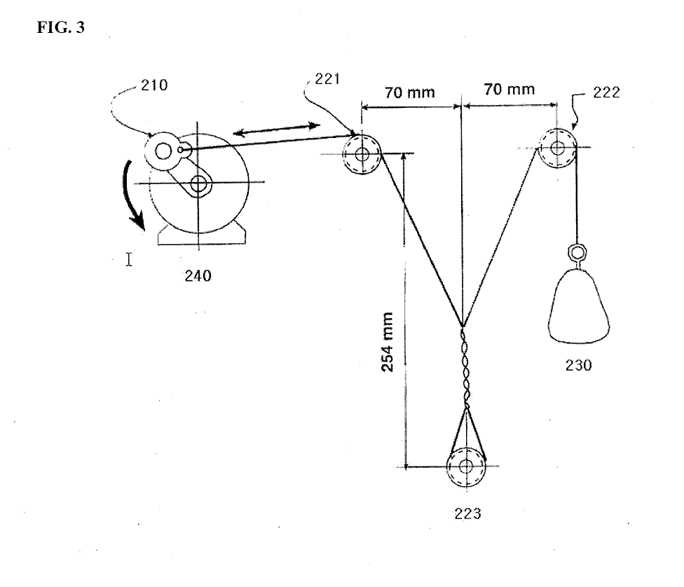

In one preferred embodiment of the present invention, the yarn-on-yarn abrasion resistance may be measured using an apparatus shown in FIG. 3. In the test apparatus, tension weight 230 moves up and down through pulleys 221˜222 by one cycle of a crank 210 driven by a gear motor 240. At this time, the yarn moves around pulley 223, and friction frequency between the yarns are measured and recorded. In addition, the abrasion resistance under dry conditions is measured at relative humidity 55% to 75% and 16 to 25° C. The yarn-on-yarn abrasion resistance under wet conditions is measured using the above apparatus, after the yarn is sufficiently soaked by immersion in water at 16 to 25° C., for example, in a water bath for approximately 1 hour or longer.

The polyester yarn of the present invention is also advantageous in that it has high strength, and excellent creep and work recovery properties so as to show excellent shape stability when applied to the marine fiber, and the polyester yarn minimizes the reduction in physical properties such as the strength even though immersed in seawater for a long time.

The polyester yarn of the present invention has a strength retention rate of 50% or more, and preferably 60% or more, which is calculated from a strength percentage before and after the abrasion resistance test is performed 1,000 cycles using the test apparatus shown in FIG. 3. The yarn obtained after performing 1,000-cycle abrasion test using the test apparatus of FIG. 3 has excellent strength retention rate, thereby showing excellent performances when applied as the marine fiber yarn.

The matters except that disclosed above are not particularly limited because they may be added or subtracted according to the necessity in the present invention.

As explained, the present invention provides a marine polyester yarn having high strength and excellent abrasion resistance and work recovery properties by surface-treatment of a polyester fiber with an oil component, and a preparation method thereof.

Owing to the high strength and excellent abrasion resistance, the polyester yarn minimizes frictional heat due to environmental changes. In addition, owing to its excellent creep and work recovery properties, the polyester yarn has no partial breakage and shows excellent mechanical properties and shape stability, when used as a marine fiber rope for a long time.

Therefore, the polyester yarn of the present invention can be very desirably used as a marine yarn.

### EXAMPLES

Hereinafter, preferable examples and comparative examples are presented for understanding the present invention. However, the following examples are only for illustrating the present invention and the present invention is not limited to or by them.

### Example 1

Solid phase polymerized polyester chips having an intrinsic viscosity of 1.05 g/dL and polyethylene terephthalate of 90% by weight or more were melted at 280° C. or higher, and the melted polyester was extruded through a spinneret. Delayed quenching of the extruded molten polyester was carried out at a hood-heater temperature of 300° C., and the quenched polyester fiber was surface-treated with a spinning oil component containing polydimethylsiloxane (number-average molecular weight of 100,000, viscosity of 350 cst) using an oil-roll. At this time, polydimethylsiloxane of 50% by weight and a typical spinning solvent (normal paraffin) of 50% by weight as a solvent were contained in the spinning oil.

The surface-treated polyester fiber was passed through a pre-interlacer, and drawn by godet rollers at a winding speed of 3,000 m/min. At this time, the solvent was dried and removed during the drawing process.

After the drawing process, the intermingling of the drawn polyester fiber was performed by a second interlacer at air pressure of 3.0 kg/cm2, and wound using a winder to finally prepare a marine polyester yarn prepared by surface-treatment of the polyester fiber with the oil component.

The oil component was extracted from the prepared polyester yarn using carbon tetrachloride according to an extraction method, and the composition was analyzed by chromatography. As a result, it was found that polydimethylsiloxane of 95% by weight was contained based on the total weight of the oil component.

### Example 2

A marine polyester yarn was prepared in the same manner as in Example 1, except that the polyester fiber was surface-treated with a spinning oil component containing polydimethylsiloxane of 20% by weight (number-average molecular weight of 100,000, viscosity of 350 cst) and water of 80% by weight as a solvent.

The oil component was extracted from the prepared polyester yarn using carbon tetrachloride according to an extraction method, and the composition was analyzed by chromatography. As a result, it was found that polydimethylsiloxane of 95% by weight was contained based on the total weight of the oil component.

### Example 3

A marine polyester yarn was prepared in the same manner as in Example 1, except that the polyester fiber was surface-treated with a spinning oil component containing polydimethylsiloxane of 30% by weight (number-average molecular weight of 100,000, viscosity of 350 cst), an emulsifying agent of 10% by weight, and a typical spinning solvent of 70% by weight.

The oil component was extracted from the prepared polyester yarn using carbon tetrachloride according to an extraction method, and the composition was analyzed by chromatography. As a result, it was found that polydimethylsiloxane of 90% by weight and the emulsifying agent of 5% by weight were contained based on the total weight of the oil component.

### Example 4

A marine polyester yarn was prepared in the same manner as in Example 1, except that the polyester fiber was surface-treated with a spinning oil component containing polydimethylsiloxane of 25% by weight (number-average molecular weight of 100,000, viscosity of 350 cst), an emulsifying agent of 5% by weight, and a typical spinning solvent of 70% by weight.

The oil component was extracted from the prepared polyester yarn using carbon tetrachloride according to an extraction method, and the composition was analyzed by chromatography. As a result, it was found that polydimethylsiloxane of 95% by weight and the emulsifying agent of 2% by weight were contained based on the total weight of the oil component.

### Example 5

A marine polyester yarn was prepared in the same manner as in Example 1, except that the polyester fiber was surface-treated with a spinning oil component containing polydimethylsiloxane of 20% by weight (number-average molecular weight of 100,000, viscosity of 350 cst), an emulsifying agent of 10% by weight, and a typical spinning solvent of 70% by weight.

The oil component was extracted from the prepared polyester yarn using carbon tetrachloride according to an extraction method, and the composition was analyzed by chromatography. As a result, it was found that polydimethylsiloxane of 90% by weight and the emulsifying agent of 5% by weight were only contained based on the total weight of the oil component.

### Comparative Example 1

A polyester yarn was prepared in the same manner as in Example 4, except that the quenched polyester fiber was surface-treated with a spinning oil component containing mineral oil of 30% by weight instead of polydimethylsiloxane, and a typical spinning solvent of 70% by weight.

The oil component was extracted from the prepared polyester yarn using carbon tetrachloride according to an extraction method, and the composition was analyzed by chromatography. As a result, it was found that mineral oil of 95% by weight was only contained based on the total weight of the oil component.

### Comparative Example 2

A polyester yarn was prepared in the same manner as in Example 4, except that the quenched polyester fiber was surface-treated with a spinning oil component containing ethylene oxide-added diol ester of 30% by weight instead of polydimethylsiloxane, and a typical spinning solvent of 70% by weight.

The oil component was extracted from the prepared polyester yarn using carbon tetrachloride according to an extraction method, and the composition was analyzed by chromatography. As a result, it was found that ethylene oxide-added diol ester of 95% by weight was only contained based on the total weight of the oil component.

The composition of the oil component used in Examples 1˜5 and Comparative Examples 1˜2 and the content of oil component in the prepared polyester yarn measured as above are shown in the following Table 1.

TABLE 1

| | Oil component | | | | | Content of |
|---|---|---|---|---|---|---|
| | | | Emulsifying | | | polysiloxane/ |
| | Lubricant | | agent | Solvent | | lubricant in |
| | | Content | Content | | Content | PET fiber |
| Section | Ingredient | (wt %) | (wt %) | Ingredient | (wt %) | (wt %) |
| Example 1 | Polydimethyl- | 50 | 0 | a typical | 50 | 0.9 |
| | siloxane | | | spinning | | |
| | | | | solvent | | |
| Example 2 | Polydimethyl- | 20 | 0 | Water | 80 | 0.9 |
| | siloxane | | | | | |
| Example 3 | Polydimethyl- | 30 | 10 | a typical | 70 | 0.9 |
| | siloxane | | | spinning | | |
| | | | | solvent | | |
| Example 4 | Polydimethyl- | 25 | 5 | a typical | 70 | 0.9 |
| | siloxane | | | spinning | | |
| | | | | solvent | | |
| Example 5 | Polydimethyl- | 20 | 10 | a typical | 70 | 0.9 |
| | siloxane | | | spinning | | |
| | | | | solvent | | |
| Comparative | Mineral oil | 30 | 0 | a typical | 70 | 0.9 |
| Example 1 | | | | spinning | | |
| | | | | solvent | | |
| Comparative | Ethylene | 30 | 0 | a typical | 70 | 0.9 |
| Example 2 | oxide-added | | | spinning | | |
| | diol ester | | | solvent | | |

The creep rate of each polyester yarn prepared according to Examples 1˜5 and Comparative Examples 1˜2 was measured by the following method, and the results are shown in the following Table 2.

Measurement of Creep Rate

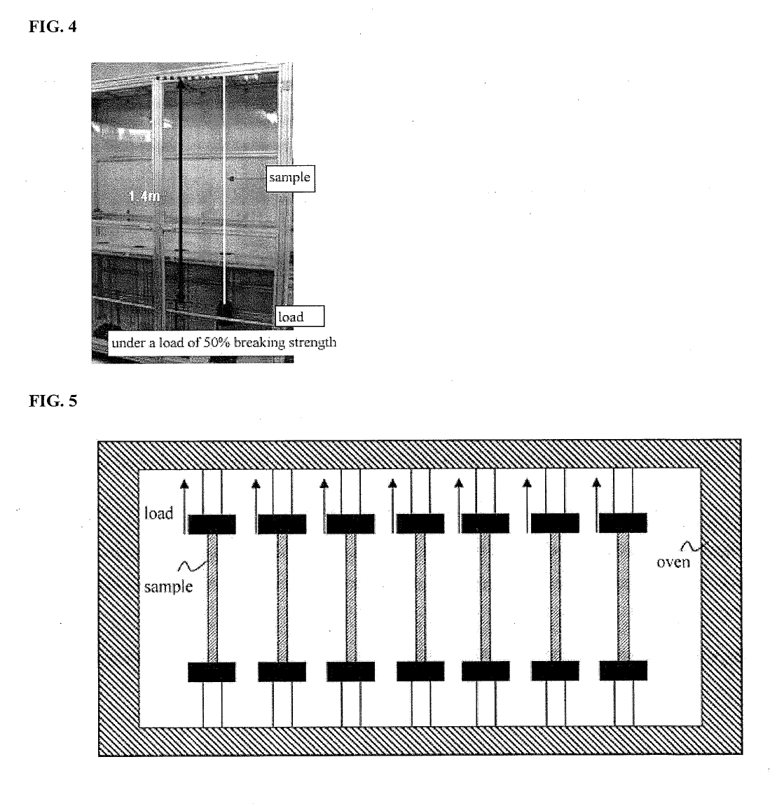

The creep rate was measured using a creep tester as shown in FIG. 4. An initial load of 50% breaking strength was applied to the polyester yarns of Examples 1 to 5 and Comparative Examples 1 to 2 (initial length L₀=1,400 mm) and the length change was measured using a creep tester.

Creep rate=(L−L₀)/L₀×100 [Equation 1]

wherein L is a deformed length after applying a load, and

L₀ is an initial length of 1.4 m when a sample is fixed in a creep tester.

At this time, the creep rate of each polyester yarn of Examples 1 to 5 and Comparative Examples 1 to 2 was measured while the drawing process was performed by varying the measurement conditions as shown in the following Table 2.

TABLE 2

| Section | | Creep rate (%) | | | | |
|---|---|---|---|---|---|---|
| Measurement | Spin-draw | 5.3 | 5.3 | 5.9 | 5.9 | 6.3 |
| conditions | ratio (times) | | | | | |
| | Relaxation | 1.8 | 1.8 | 1.8 | 1.8 | 1.8 |
| | rate (%) | | | | | |
| | Heat treatment | 210 | 240 | 210 | 240 | 210 |
| | temperature | | | | | |
| | (° C.) | | | | | |

| | | | | | |
|---|---|---|---|---|---|
| Example 1 | 8.0 | 7.5 | 7.0 | 7.2 | 6.0 |
| Example 2 | 8.5 | 8.7 | 8.0 | 8.3 | 7.0 |
| Example 3 | 7.0 | 7.5 | 6.0 | 6.5 | 5.5 |
| Example 4 | 6.5 | 7.0 | 5.0 | 5.5 | 4.5 |
| Example 5 | 7.0 | 7.5 | 5.5 | 6.0 | 5.0 |
| Comparative | 10.5 | 10.0 | 9.5 | 9.8 | 9.3 |
| Example 1 | | | | | |
| Comparative | 11.0 | 9.5 | 9.3 | 9.6 | Not |
| Example 2 | | | | | manufac- |
| | | | | | turable |

The work recovery of each polyester yarn of Examples 1 to 5 and Comparative Examples 1 to 2 was measured according to the following method, and the results are shown in the following Table 3.

Measurement of Work Recovery

Work recovery (Energy Recovery) was measured using a universal tensile machine (manufactured by Instron) as shown in FIG. 5 according to the ASTM D885 method of the American Society for Testing and Materials.

A cycling test of the polyester yarns of Examples 1 to 5 and Comparative Examples 1 to 2 was performed 5 to 10 times using a universal tensile machine at 25° C. under the load of 3.5 and 6.5 g/d. Then, Work returned during Recovery and Total Work done in Extension were measured, and the work recovery of each polyester yarn was calculated from the following Equation 2 using the measured values.

Work recovery (%)=W₂/W₁×100 [Equation 2]

wherein W₁ is Total Work done in Extension in the cycling test according to the ASTM D885 method of the American Society for Testing and Materials, and

W₂ is Work returned during Recovery in the cycling test according to the ASTM D885 method of the American Society for Testing and Materials.

The results of the work recovery measurement are shown in the following Table 3.

TABLE 3

| Section | | Work recovery (%) | | | |
|---|---|---|---|---|---|
| Measurement | Temperature (° C.) | 25 | 25 | 25 | 25 |
| conditions | Load (g/d) | 3.5 | 3.5 | 6.5 | 6.5 |
| | Cycling (repeat) | 5 | 10 | 5 | 10 |

| | | | | |
|---|---|---|---|---|
| Example 1 | 61 | 55 | 54 | 50 |
| Example 2 | 68 | 62 | 60 | 56 |
| Example 3 | 72 | 67 | 62 | 58 |
| Example 4 | 78 | 73 | 69 | 65 |
| Example 5 | 63 | 56 | 56 | 52 |
| Comparative Example 1 | 53 | 50 | 48 | 45 |
| Comparative Example 2 | 53 | 49 | 48 | 43 |

In addition, the physical properties of each polyester yarn of Examples 1 to 5 and Comparative Examples 1 to 2 were evaluated according to the following method, and the results are shown in the following Table 4.

Evaluation of Yarn-on-Yarn Abrasion Resistance

As shown in FIG. 3, friction frequency between the moving yarns are measured and recorded, while the load moves up and down during one cycle of crank. The abrasion resistance of each yarn was measured under dry and wet conditions. The abrasion resistance test under dry conditions was performed after the yarns were dried at relative humidity 55% to 75% and 16 to 25° C. for approximately 1 hour. The abrasion resistance test under wet conditions was performed after the yarns were sufficiently soaked by immersion in a water bath at 16 to 25° C. for approximately 1 hour or longer.

In the present invention, the yarn-on-yarn abrasion resistance was evaluated by rubbing 2,000 De yarns under a load of 700 g until yarn breakage occurred.

Strength Retention Rate

The strength retention rate of the yarns, which were collected after 1,000-cycle abrasion test of the polyester yarns of Example 1˜5 and Comparative Example 1˜2 was performed using the test apparatus of FIG. 3, were measured using an Instron machine according to the ASTM D2256 method.

TABLE 4

| | Result of abrasion | | | | |
|---|---|---|---|---|---|
| | resistance measurement | | | | |
| | (cycles) | | | | Strength |
| | Dry | Wet | Strength | Breakage | retention |
| Section | conditions | conditions | (g/d) | (%) | rate (%) |
| Example 1 | 7,100 | 5,123 | 9.2 | 14 | 75 |
| Example 2 | 10,324 | 9,120 | 9.4 | 13 | 80 |
| Example 3 | 11,352 | 9,317 | 9.4 | 13 | 82 |
| Example 4 | 12,235 | 9,850 | 9.6 | 12 | 85 |
| Example 5 | 10,021 | 8,701 | 9.6 | 12 | 80 |
| Comparative | 4,210 | 3,258 | 9.4 | 13 | 60 |
| Example 1 | | | | | |
| Comparative | 4,027 | 3,019 | 9.2 | 14 | 55 |
| Example 2 | | | | | |

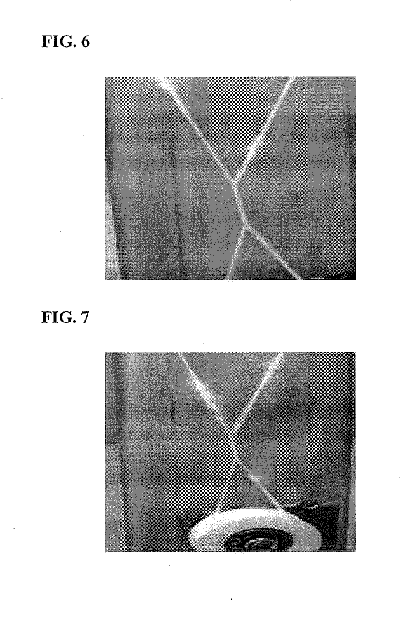

Together with the results of the physical property test, the results of the abrasion resistance test of Example 4 and Comparative Example 1 are shown in FIGS. 6 and 7, respectively.

As shown in Tables 1˜4, the polyester yarns of Example 1˜5 which were surface-treated with the oil component having high content of polysiloxane compound according to the present invention showed up to approximately 4.8% lower creep rate than the polyester yarns of Comparative Examples 1˜2 which were surface-treated with the typical fiber treatment oil component, mineral oil or ethylene oxide-added diol ester. Owing to the excellent creep properties, the polyester yarn of the present invention showed remarkably excellent properties in terms of strength and strength retention rate.

Under the load conditions of 3.5 and 6.5 g/d, the polyester yarns of Examples 1˜5 had the work recovery of 55% or more and 50% or more, respectively, and they showed up to 25% higher work recovery than the polyester yarns of Comparative Examples 1˜2.

In addition, the polyester yarns of Examples 1˜5 showed excellent abrasion resistance of 7,100 cycles to 12,235 cycles and 5,123 cycles to 9,850 cycles under dry and wet conditions, respectively. At this time, they also had the very excellent strength retention rates of 75% to 85%. On the contrary, the polyester yarns of Comparative Examples 1˜2 showed very low abrasion resistance of 4,210 cycles to 4,027 cycles and 3,258 cycles to 3,019 cycles under dry and wet conditions, respectively. At this time, they also had the low strength retention rates of 55% to 60%. Thus, complete breakage may be caused by the remarkably low mechanical strength, abrasion resistance, and shape stability, when they are used as a marine yarn for a long time.

In particular, the polyester yarns of Examples 1˜5 showed at least 1.5 times higher abrasion resistance than the polyester yarn of Comparative Examples 1 which was surface-treated with the typical fiber treatment oil component, mineral oil. Moreover, the polyester yarn of Comparative Examples 2 which was surface-treated with ethylene oxide-added diol ester had lower lubricity to show the remarkably low abrasion resistance.

The abrasion resistance of the yarn can be detected with the naked eye in the photographs of FIGS. 6 and 7. The polyester yarn of Example 4 that was surface-treated with polydimethylsiloxane according to the present invention had higher surface lubricity to show very excellent abrasion resistance, compared to the polyester yarn of Comparative Examples 1 that was surface-treated with mineral oil.

As such, the polyester yarn of the present invention is excellent in terms of strength, abrasion resistance, and work recovery properties. Thus, it is a lightweight fiber rope, compared to the known wire ropes, and can be conveniently used as a marine yarn. Simultaneously, it minimizes frictional heat or deformation due to environmental changes, thereby being used for a long time without damages such as partial breakage.

While this disclosure has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A marine polyester yarn that is prepared by surface-treatment of a polyester fiber with an oil component,
wherein a creep rate defined by the following Equation 1 is 9% or less when the fiber is fixed to have an initial length of 1.4 m and is left for 24 hours under a load of 50% breaking strength of the yarn:
Creep rate=(L−L₀)/L₀×100 Equation 1
wherein
L is a deformed length after keeping it for 24 hours under a load, and
L₀ is an initial length of the yarn to be 1.4 m.

2. The marine polyester yarn according to claim 1, wherein the yarn has a breaking strength of 15 kgf to 25 kgf.

3. A marine polyester yarn that is prepared by surface-treatment of a polyester yarn with an oil component,
wherein the work recovery defined by the following Equation 2 is 55% or more when a cycling test is performed 5 to 10 times under a load of 3.5 g/d according to the ASTM D885 method of the American Society for Testing and Materials,
the work recovery defined by the following Equation 2 is 50% or more when a cycling test is performed 5 to 10 times under a load of 6.5 g/d according to the ASTM D885 method of the American Society for Testing and Materials:
Work recovery (%)=W₂/W₁×100 Equation 2
wherein
W₁ is Total Work done in Extension in the cycling test according to the ASTM D885 method of the American Society for Testing and Materials, and
W₂ is Work returned during Recovery in the cycling test according to the ASTM D885 method of the American Society for Testing and Materials.

4. The marine polyester yarn according to claim 3, wherein the work recovery is 75% or more under a load of 2.0 g/d.

5. The marine polyester yarn according to claim 3, wherein the work recovery is 35% or more under a load of 8.5 g/d.

6. The marine polyester yarn according to claim 1, wherein the polysiloxane compound is contained in an amount of 40% by weight or more, based on the total weight of the oil component of the yarn.

7. The marine polyester yarn according to claim 1, wherein the polysiloxane compound is represented by the following Chemical Formula 1: 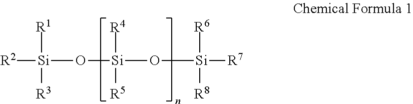
wherein
R¹, R², R³, R⁴, R⁵, R⁶, and R⁷ are independently the same as or different from each other, and hydrogen, C₁˜C₂₀ alkyl group, or C₁˜C₂₀ aryl group, and
n is an integer of 1˜10,000.

8. The marine polyester yarn according to claim 1, wherein the polysiloxane compound has a number-average molecular weight of 10 to 30,000.

9. The marine polyester yarn according to claim 1, wherein the polysiloxane compound has a viscosity of 5 to 35,000 cst.

10. The marine polyester yarn according to claim 7, wherein the polysiloxane compound has alkyl having 1 to 4 carbon atoms as at least one of R⁴ or R⁵.

11. The marine polyester yarn according to claim 7, wherein the polysiloxane compound is one or more selected from the group consisting of polydimethylsiloxane, polydiethylsiloxane, and polymethylphenylsiloxane.

12. The marine polyester yarn according to claim 7, wherein the oil component further contains an emulsifying agent.

13. The marine polyester yarn according to claim 12, wherein the emulsifying agent is contained in an amount of 60% by weight or less, based on the total weight of the oil component of the yarn.

14. The marine polyester yarn according to claim 12, wherein the emulsifying agent is one or more selected from the group consisting of a fatty acid monoglycerin ester non-ionic surfactant, a fatty acid polyglycol ester non-ionic surfactant, a fatty acid sorbitan ester non-ionic surfactant, a fatty acid sucrose ester non-ionic surfactant, a fatty acid alkanolamide non-ionic surfactant, and a polyethylene glycol condensed non-ionic surfactant, and the fatty acid has 8˜22 carbon atoms.

15. The marine polyester yarn according to claim 12, wherein the oil component is only composed of the polysiloxane compound and the emulsifying agent.

16. The marine polyester yarn according to claim 1, wherein the oil component is only composed of the polysiloxane compound.

17. The marine polyester yarn according to claim 1, wherein the polyester fiber has an intrinsic viscosity of 8.0 to 1.20 dl/g.

18. The marine polyester yarn according to claim 1, wherein the polyester fiber is selected from the group consisting of polyethylene terephthalate, polyethylene naphthalate, polybutylene terephthalate, polycyclohexanedimethylene terephthalate, and copolyesters thereof.

19. The marine polyester yarn according to claim 1, wherein the marine polyester yarn has an abrasion resistance showing a yarn breakage when yarns are rubbed 5,000 cycles or more under a load of 0.34 to 0.45 g/d.

20. The marine polyester yarn according to claim 1, wherein the marine polyester yarn has a strength retention rate of 50% or more when yarns are rubbed 1,000 cycles or more under a load of 0.34 to 0.45 g/d.

21. A method for preparing a marine polyester yarn, comprising the steps of:
melt-spinning a polyester polymer to prepare an undrawn polyester filament yarn,
surface-treating the undrawn polyester filament yarn with an oil composition containing a polysiloxane compound, and
drawing the undrawn polyester filament yarn under the heat treatment condition of 70 to 250° C. to contain the polysiloxane compound of 40% by weight or more based on the total weight of the oil component surface-treated to the yarn.

22. The method according to claim 21, wherein the drawing step is performed under the conditions of a drawing ratio of 4 to 7, a relaxation rate of 1% or more, and a winding speed of 2,500 m/min or more.

23. The method according to claim 21, wherein the oil composition is only composed of a polysiloxane compound, an emulsifying agent, and a solvent.

24. The method according to claim 23, wherein the oil composition contains the polysiloxane compound of 15 to 25% by weight, the emulsifying agent of 10% by weight or less, and the residual solvent.

25. The method according to claim 23, wherein the solvent is one or more selected from the group consisting of water, and petroleum-extracted normal paraffin or isoparaffin having 9 to 13 carbon atoms.

26. The marine polyester yarn according to claim 3, wherein the polysiloxane compound is contained in an amount of 40% by weight or more, based on the total weight of the oil component of the yarn.

27. The marine polyester yarn according to claim 3, wherein the polysiloxane compound is represented by the following Chemical Formula 1: 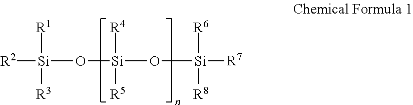
wherein
R¹, R², R³, R⁴, R⁵, R⁶, and R⁷ are independently the same as or different from each other, and hydrogen, C₁˜C₂₀ alkyl group, or C₁˜C₂₀ aryl group, and
n is an integer of 1˜10,000.

28. The marine polyester yarn according to claim 3, wherein the polysiloxane compound has a number-average molecular weight of 10 to 30,000.

29. The marine polyester yarn according to claim 3, wherein the polysiloxane compound has a viscosity of 5 to 35,000 cst.

30. The marine polyester yarn according to claim 27, wherein the polysiloxane compound has alkyl having 1 to 4 carbon atoms as at least one of R⁴ or R⁵.

31. The marine polyester yarn according to claim 27, wherein the polysiloxane compound is one or more selected from the group consisting of polydimethylsiloxane, polydiethylsiloxane, and polymethylphenylsiloxane.

32. The marine polyester yarn according to claim 27, wherein the oil component further contains an emulsifying agent.

33. The marine polyester yarn according to claim 32, wherein the emulsifying agent is contained in an amount of 60% by weight or less, based on the total weight of the oil component of the yarn.

34. The marine polyester yarn according to claim 32, wherein the emulsifying agent is one or more selected from the group consisting of a fatty acid monoglycerin ester non-ionic surfactant, a fatty acid polyglycol ester non-ionic surfactant, a fatty acid sorbitan ester non-ionic surfactant, a fatty acid sucrose ester non-ionic surfactant, a fatty acid alkanolamide non-ionic surfactant, and a polyethylene glycol condensed non-ionic surfactant, and the fatty acid has 8˜22 carbon atoms.

35. The marine polyester yarn according to claim 32, wherein the oil component is only composed of the polysiloxane compound and the emulsifying agent.

36. The marine polyester yarn according to claim 3, wherein the oil component is only composed of the polysiloxane compound.

37. The marine polyester yarn according to claim 3, wherein the polyester fiber has an intrinsic viscosity of 8.0 to 1.20 dl/g.

38. The marine polyester yarn according to claim 3, wherein the polyester fiber is selected from the group consisting of polyethylene terephthalate, polyethylene naphthalate, polybutylene terephthalate, polycyclohexanedimethylene terephthalate, and copolyesters thereof.

39. The marine polyester yarn according to claim 3, wherein the marine polyester yarn has an abrasion resistance showing a yarn breakage when yarns are rubbed 5,000 cycles or more under a load of 0.34 to 0.45 g/d.

40. The marine polyester yarn according to claim 3, wherein the marine polyester yarn has a strength retention rate of 50% or more when yarns are rubbed 1,000 cycles or more under a load of 0.34 to 0.45 g/d.
